(19) United States
(12) Patent Application Publication
(10) Pub. No.: US 2016/0340550 A1
(43) Pub. Date: Nov. 24, 2016

(54) AQUEOUS COMPOSITION, HARD COAT FILM, LAMINATED FILM, TRANSPARENT CONDUCTIVE FILM, AND TOUCH PANEL

(71) Applicant: FUJIFILM Corporation, Tokyo (JP)

(72) Inventors: Naoki TSUKAMOTO, Fujinomiya-shi (JP); Aya NAKAYAMA, Fujinomiya-shi (JP)

(73) Assignee: FUJIFILM Corporation, Tokyo (JP)

(21) Appl. No.: 15/228,045

(22) Filed: Aug. 4, 2016

Related U.S. Application Data
(63) Continuation of application No. PCT/JP2015/050732, filed on Jan. 14, 2015.

(30) Foreign Application Priority Data
Feb. 28, 2014 (JP) 2014-038292

(51) Int. Cl. C09D 183/06; G06F 3/041; C08G 77/08; C09D 7/12; C08G 77/18

(52) U.S. Cl. CPC C09D 183/06; C09D 7/1266; C09D 7/1275; C09D 7/1216; C08G 77/18; C08G 77/08; G06F 3/041; C08K 3/36

(57) ABSTRACT

An aqueous composition contains alkoxy silane containing an epoxy group, alkoxy silane not containing an epoxy group, inorganic particles having an average particle diameter of 60 nm to 350 nm, and a metal complex, in which the inorganic particles satisfy Expression (I); Expression (I): A=−0.1×B+C. Here, A represents a ratio of the inorganic particles to the total solid content, B represents the average particle diameter of the inorganic particles, A is a value in terms of volume %, B is a value in terms of nm; and C represents a coefficient and satisfies a relationship of 50≦C≦70.

### CROSS-REFERENCE TO RELATED APPLICATIONS

This application is a Continuation of PCT International Application No. PCT/JP2015/50732, filed on Jan. 14, 2015, which claims priority under 35 U.S.C. §119(a) to Japanese Patent Application No. 2014-038292, filed on Feb. 28, 2014. Each of the above application(s) is hereby expressly incorporated by reference, in its entirety, into the present application.

### BACKGROUND OF THE INVENTION

1. Field of the Invention

The present invention relates to an aqueous composition, a hard coat film, a laminated film, a transparent conductive film, and a touch panel.

2. Description of the Related Art

In order to improve scratch resistance of a substrate surface such as glass, a plastic sheet, a plastic lens, and a resin film, forming a hard coat film (also referred to as a hard coat layer) on the substrate surface has been well known. For example, the surface of a display device such as a liquid crystal display, a plasma display, and a touch panel display is in contact with various substances, and thus, is easily scratched. For this reason, in general, the hard coat layer is disposed on a surface layer of the display device. A material containing a multifunctional acrylic monomer or an oligomer is cured by being irradiated with an ultraviolet ray, an electron beam, or the like, or a hydrolysate of alkoxy silane is cured by being condensed, and thus, the hard coat layer is formed.

However, in a case where the hard coat layer of the related art is disposed on the film substrate, the hard coat layers or the substrate and the hard coat layer are bonded to each other in a case of being wound into the shape of a roll at the time of manufacturing or in a case of laminating the film after the manufacturing, and thus, it is difficult to perform peeling off after the bonding at the time of being processed or being used, and a blocking phenomenon in which a defect occurs on the external appearance or a phenomenon in which a Newton ring is generated by light interference due to a fine gap generated by the bonding occurs.

For this reason, in the related art, the bonding is prevented by laminating a protective film such as a polyethylene film at the time of winding a film attached with a hard coat layer. However, in a case where the protective film is used, the number of steps increases, and thus, costs required for the steps and the material increase. Further, in a case where the protective film is further laminated on the hard coat layer or the film attached with a hard coat layer and other substrates are bonded to each other, a step of peeling off the protective film is added, and thus, complexity increases. In addition, peeling charge occurs at the time of peeling off the protective film, and thus, not only is dust such as powder dust easily attached, but also the peeled off protective film becomes the dust, and environmental friendliness is not obtained.

A method in which a contact area is reduced by forming irregularity on the surface of the hard coat layer, and thus, blocking is prevented is proposed as means for solving the problems described above.

For example, in JP2010-163535A, a composition which is formed of a first component formed of a resin and a second component formed of a monomer is applied, and then, the resin of the first component is educed by phase separation, and thus, fine irregularity is formed on the surface.

In addition, in JP2004-151937A, a back coat layer is formed by applying a resin in which organic resin particles having a particle diameter of several μm are mixed, and thus, surface irregularity is formed on the back coat layer.

In addition, in JP2004-042653A and JP2013-136222A, inorganic particles are contained in a hard coat composition formed of an organic resin, and the surface of a hard coat layer is partially pushed up by the inorganic particles, and thus, fine irregularity is formed.

In addition, in JP2013-170013A, a manufacturing method of a hard coat film roll obtained by winding a hard coat film is disclosed in which a hard coat layer is disposed on one surface of a substrate film having a thickness of 20 μm to 55 μm, centerline average surface roughness Rah on one surface of the hard coat layer of 0.2 nm to 2.0 nm, and centerline average surface roughness Ras on the other surface of 1.0 nm to 5.0 nm.

Further, in JP5394094B, it is disclosed that an aqueous coating liquid containing an aqueous solution of alkoxy silane in which tetraalkoxy silane and an organic silicon compound are dissolved in an acidic aqueous solution having pH in a range of greater than or equal to 2 and less than or equal to 6 and a water-soluble curing agent which allows silanol generated by hydrolysis of the tetraalkoxy silane and the organic silicon compound to be subjected to dehydration and condensation without containing an organic solvent is applied onto a support and is dried, and thus, a hard coat layer is formed.

### SUMMARY OF THE INVENTION

However, in the method of obtaining the antiblocking properties by the phase separation of the resin as disclosed in JP2010-163535A, a difference in SP values of both of the components is used, and thus, the material which is able to be used is limited, sufficient hard coating properties may not be generally obtained, and a stable effect is rarely obtained as being easily affected by drying temperature conditions or the like during film formation.

In addition, in the method of obtaining antiblocking properties by disposing the particles of several μm on the back coat layer as disclosed in JP2004-151937A, it is necessary that the irregularity of the particles appears on the surface, and thus, the thickness of the coated film is required to be smaller than the particle diameter, the mechanical strength of the back coat layer decreases, and the visibility of the particles may deteriorate.

In addition, in the method of obtaining the antiblocking properties by containing the inorganic particles in the hard coat composition of the organic resin as disclosed in JP2004-042653A and JP2013-136222A, an increase in internal scattering occurs due to a difference in refractive indices between the inorganic particles and the organic resin, and transparency decreases. Alternatively, in order to suppress the increase in the internal scattering, a step for performing a surface treatment with respect to the inorganic particles is necessary.

In the hard coat layer containing the inorganic particles by using alkoxy silane as a binder as disclosed in JP5394094B, internal scattering due to a difference in refractive indices of the binder and the particles does not occur, but fine particles of tens of nm are used, and thus, surface irregularity rarely appears. For this reason, a blocking phenomenon easily occurs, and thus, a step of bonding a laminated film (the protective film) is necessary.

In all of JP2010-163535A, JP2004-151937A, JP2004-042653A, and JP2013-136222A, the hard coat is formed of the organic resin, and thus, it is necessary that the film thickness is set to be 3 μm to 5 μm in order to obtain hard coating properties. In a case where the hard coat layer is applied onto one surface of the film substrate, the film substrate is curled due to curing and contraction of the hard coat layer, and thus, handling is required to be improved. In addition, JP2010-163535A, JP2004-151937A, JP2004-042653A, JP2013-136222A, and JP2013-170013A, the organic solvent is used as a solvent, and thus, a load on the environment increases, and the manufacturing environment deteriorates due to volatilization of the organic solvent in a manufacturing step.

Therefore, in order to solve the problems of the related art, the present inventors have conducted studies for providing an aqueous composition for forming a hard coat layer, a hard coat film, or the like which has antiblocking properties. In addition, the present inventors have conducted studies for increasing not only the antiblocking properties but also hard coating properties and transparency, and for suppressing curling in a hard coat film to be obtained.

As a result of intensive studies for attaining the object described above, the present inventors have found that a hard coat film having high antiblocking properties and low haze is able to be obtained by using an aqueous composition in which alkoxy silane containing an epoxy group, alkoxy silane not containing an epoxy group, inorganic particles which have an average particle diameter of 60 nm to 350 nm and satisfy a predetermined relational expression, and a metal complex are mixed at a predetermined ratio. In particular, it has been found that high antiblocking properties are able to be obtained by adding the inorganic particles in the amount of greater than the general amount.

Specifically, the present invention has the following configurations.

<1> An aqueous composition, containing: alkoxy silane containing an epoxy group; alkoxy silane not containing an epoxy group; inorganic particles having an average particle diameter of 60 nm to 350 nm; and a metal complex, in which the inorganic particles satisfy Expression (I); Expression (I): A=−0.1×B+C, here, A represents a ratio of the inorganic particles to the total solid content of the aqueous composition, B represents the average particle diameter of the inorganic particles, A is a value in terms of volume %, B is a value in terms of nm; and C represents a coefficient and satisfies a relationship of 50≦C≦70.

<2> The aqueous composition according to <1>, in which the inorganic particles are silica particles.

<3> The aqueous composition according to <1> or <2>, in which a ratio of the alkoxy silane containing an epoxy group to the total mass of the alkoxy silane containing an epoxy group and the alkoxy silane not containing an epoxy group is 20 mass % to 85 mass %.

<4> The aqueous composition according to any one of <1> to <3>, in which the metal complex is an aluminum chelate.

<5> The aqueous composition according to any one of <1> to <4>, in which the average particle diameter of the inorganic particles is 70 nm to 250 nm.

<6> The aqueous composition according to any one of <1> to <5>, in which a ratio of the inorganic particles to the total solid content of the aqueous composition is 30 volume % to 60 volume %.

<7> A hard coat film formed by curing the aqueous composition according to any one of <1> to <6>.

<8> The hard coat film according to <7>, in which centerline average surface roughness Ra is 1.0 nm to 4.0 nm.

<9> The hard coat film according to <7> or <8>, in which a film thickness is 0.6 μm to 1.8 μm.

<10> A laminated film, comprising: a substrate film; and the hard coat film according to any one of <7> to <9> which is formed on at least one surface of the substrate film.

<11> A laminated film, sequentially comprising: a substrate film; an easily adhesive layer; the hard coat film according to any one of <7> to <9>; and an optical adjustment layer.

<12> A transparent conductive film, comprising: the hard coat film according to any one of <7> to <9>; and a transparent conductive layer formed on the hard coat film.

<13> A touch panel, comprising: the laminated film according to <10> or <11>.

<14> A touch panel, comprising: the transparent conductive film according to <12>.

According to the present invention, it is possible to obtain a hard coat film having high antiblocking properties and high hardness, low haze, and suppressed curling of the film. In addition, according to the present invention, an increase in the haze is suppressed, and thus, it is possible to obtain a hard coat film having excellent optical properties. Further, according to the present invention, it is possible to obtain a laminated film including the hard coat film having high hardness and suppressed curling of the film.

### DESCRIPTION OF THE PREFERRED EMBODIMENTS

Hereinafter, the present invention will be described in detail. The description of configuration requirements described below is based on representative embodiments or specific examples, but the present invention is not limited to the embodiments. Furthermore, herein, a numerical range denoted by using “to” indicates a range including numerical values before and after “to” as the lower limit value and the upper limit value.

(Aqueous Composition)

An aqueous composition of the present invention contains alkoxy silane containing an epoxy group, alkoxy silane not containing an epoxy group, inorganic particles having an average particle diameter of 60 nm to 350 nm, and a metal complex, and the inorganic particles satisfy Expression (I).

A=−0.1×B+C Expression (I):

Here, A represents a ratio of the inorganic particles to the total solid content of the aqueous composition, B represents the average particle diameter of the inorganic particles, the unit of A is volume %, the unit of B is nm; and C represents a coefficient and satisfies a relationship of 50≦C≦70.

The aqueous composition described above is applied onto a substrate film, and is cured, and thus, a hard coat film (a hard coat layer) is formed. That is, aqueous composition of the present invention is able to be an aqueous composition for forming a hard coat film.

In the aqueous composition of the present invention, a component which is evaporated at the time of applying and drying the aqueous composition is mainly a water component. For this reason, it is possible to considerably reduce a load on the environment, compared to a case where a composition containing an organic solvent is used as a solvent. Further, by setting the aqueous composition of the present invention to have the configuration described above, it is possible to obtain a hard coat film having high antiblocking properties. In the hard coat film formed by using the aqueous composition of the present invention, an increase in haze is suppressed, and thus, it is possible to obtain a hard coat film having excellent optical performance.

(Alkoxy Silane Containing Epoxy Group and Alkoxy Silane not Containing Epoxy Group)

The aqueous composition of the present invention contains the alkoxy silane containing an epoxy group and the alkoxy silane not containing an epoxy group (hereinafter, the alkoxy silane containing an epoxy group and the alkoxy silane not containing an epoxy group will be collectively referred to as “alkoxy silane”). It is preferable that a water-soluble material or a water-dispersible material is used as the alkoxy silane. It is particularly preferable to use the water-soluble material or the water-dispersibility material from the viewpoint of reducing environmental pollution due to volatile organic compounds (VOC).

Each of the alkoxy silane containing an epoxy group and the alkoxy silane not containing an epoxy group has a hydrolytic group. The hydrolytic group is hydrolyzed in an acidic aqueous solution, and thus, silanol is generated, and silanols are condensed with each other, and thus, an oligomer is generated. In the aqueous composition of the present invention, a part of the alkoxy silane containing an epoxy group and the alkoxy silane not containing an epoxy group may be hydrolyzed.

It is preferable that a ratio of the alkoxy silane containing an epoxy group to the total of the alkoxy silane formed of the alkoxy silane containing an epoxy group and the alkoxy silane not containing an epoxy group is 20 mass % to 100 mass %. The ratio of the alkoxy silane containing an epoxy group to the total of the alkoxy silane is preferably greater than or equal to 20 mass %, is more preferably greater than or equal to 25 mass %, and is even more preferably greater than or equal to 30 mass %. In addition, the ratio of the alkoxy silane containing an epoxy group to the total of the alkoxy silane is preferably less than or equal to 100 mass %, is more preferably less than or equal to 90 mass %, and is even more preferably less than or equal to 85 mass %. By setting the ratio of the alkoxy silane containing an epoxy group to the total of the alkoxy silane to be in the range described above, it is possible to increase the stability of the aqueous composition and to form a hard coat film having high alkali resistance.

The alkoxy silane containing an epoxy group is alkoxy silane having an epoxy group. In the alkoxy silane containing an epoxy group, the number of epoxy groups is not particularly limited insofar as one or more epoxy groups are included in one molecule. The alkoxy silane containing an epoxy group may have a group other than the epoxy group, such as an alkyl group, an amide group, a urethane group, a urea group, an ester group, a hydroxy group, and a carboxyl group.

Examples of the alkoxy silane containing an epoxy group which is used in an embodiment of the present invention are able to include 2-(3,4-epoxy cyclohexyl)ethyl trimethoxy silane, 2-(3,4-epoxy cyclohexyl) ethyl triethoxy silane, 2-(3,4-epoxy cyclohexyl) ethyl triethoxy silane, 2-(3,4-epoxy cyclohexyl) ethyl methyl dimethoxy silane, 2-(3,4-epoxy cyclohexyl) ethyl methyl diethoxy silane, 3-glycidoxy propyl trimethoxy silane, 3-glycidoxy propyl triethoxy silane, and the like. Examples of a commercially available product include KBE-403 (manufactured by Shin-Etsu Chemical Co., Ltd.) and the like.

The alkoxy silane not containing an epoxy group is alkoxy silane not containing an epoxy group. The alkoxy silane not containing an epoxy group may be alkoxy silane not having an epoxy group, or may have a group such as an alkyl group, an amide group, a urethane group, a urea group, an ester group, a hydroxy group, and a carboxyl group.

Examples of the alkoxy silane not containing an epoxy group include tetraalkoxy silane, trialkoxy silane, and a mixture thereof, and among them, the tetraalkoxy silane is preferable. By having the tetraalkoxy silane, it is possible to obtain sufficient hardness at the time of forming the hard coat film.

The tetraalkoxy silane is tetrafunctional alkoxy silane, and is more preferably tetraalkoxy silane in which the number of carbon atoms of each alkoxy group is 1 to 4. Among them, tetramethoxy silane and tetraethoxy silane are particularly preferably used. By setting the number of carbon atoms to be less than or equal to 4, the hydrolysis speed of the tetraalkoxy silane at the time of being mixed with acidic water does not become excessively slow, and a time required for dissolving the tetraalkoxy silane until a homogeneous aqueous solution is obtained becomes shorter. Accordingly, it is possible to increase manufacturing efficiency at the time of manufacturing the hard coat film. Examples of a commercially available product include KBE-04 (manufactured by Shin-Etsu Chemical Co., Ltd.) and the like.

The trialkoxy silane is trifunctional alkoxy silane denoted by General Formula (1) described below.

RSi(OR¹)₃ (1)

Here, R is an organic group having 1 to 15 carbon atoms in which an amino group is not included, and R¹ is an alkyl group having less than or equal to 4 carbon atoms, such as a methyl group or an ethyl group.

The trifunctional alkoxy silane denoted by General Formula (1) does not have an amino group as a functional group. That is, the trifunctional alkoxy silane has an organic group R which does not have an amino group. In a case where R has an amino group, dehydration and condensation of silanols to be generated are accelerated in a case of being mixed with the tetrafunctional alkoxy silane and of being hydrolyzed. For this reason, the aqueous composition becomes unstable, and thus, it is not preferable that R has the amino group.

R of General Formula (1) may be an organic group having a molecular chain length in which the number of carbon atoms is in a range of 1 to 15. By setting the number of carbon atoms to be less than or equal to 15, flexibility at the time of forming the hard coat film does not excessively increase, and thus, it is possible to obtain sufficient hardness. By setting the number of carbon atoms of R to be in the range described above, it is possible to obtain a hard coat film having further enhanced brittleness. In addition, it is possible to increase adhesiveness between other films such as a substrate film and the hard coat film.

Further, the organic group represented by R may have a hetero atom such as oxygen, nitrogen, and sulfur. The organic group has a hetero atom, and thus, it is possible to further improve the adhesiveness with other films.

Examples of the trialkoxy silane are able to include vinyl trimethoxy silane, 3-methacryloxy propyl trimethoxy silane, 3-acryloxy propyl trimethoxy silane, 3-chloropropyl trimethoxy silane, 3-ureidopropyl trimethoxy silane, propyl trimethoxy silane, phenyl trimethoxy silane, vinyl triethoxy silane, 3-methacryloxy propyl triethoxy silane, 3-acryloxy propyl triethoxy silane, 3-chloropropyl triethoxy silane, 3-ureidopropyl triethoxy silane, methyl triethoxy silane, methyl trimethoxy silane, ethyl triethoxy silane, ethyl trimethoxy silane, propyl triethoxy silane, propyl trimethoxy silane, phenyl triethoxy silane, and phenyl trimethoxy silane. Among them, the methyl triethoxy silane and the methyl trimethoxy silane are particularly preferably used. Examples of a commercially available product include KBE-13 (manufactured by Shin-Etsu Chemical Co., Ltd.) and the like.

(Metal Complex (Curing Agent))

The aqueous composition according to the embodiment of the present invention contains the metal complex (a curing agent). Metal complexes formed of Al, Mg, Mn, Ti, Cu, Co, Zn, Hf, and Zr are preferable as the metal complex, and are able to be used in combination.

The metal complexes are able to be easily obtained by allowing a chelating agent to react with metal alkoxide. β-diketone such as acetyl acetone, benzoyl acetone, and dibenzoyl methane; β-keto acid ester such as ethyl acetoacetate and ethyl benzoyl acetate, and the like are able to be used as an example of the chelating agent, and an aluminum chelate is preferable.

Preferred specific examples of the metal complex include an aluminum chelate compound such as ethyl acetoacetate aluminum diisopropylate, aluminum tris(ethyl acetoacetate), alkyl acetoacetate aluminum diisopropylate, aluminum monoacetyl acetate bis(ethyl acetoacetate), and aluminum tris(acetyl acetonate), a magnesium chelate compound such as ethyl acetoacetate magnesium monoisopropylate, magnesium bis(ethyl acetoacetate), alkyl acetoacetate magnesium monoisopropylate, and magnesium bis(acetyl acetonate), zirconium tetraacetyl acetonate, zirconium tributoxy acetyl acetonate, zirconium acetyl acetonate bis(ethyl acetoacetate), manganese acetyl acetonate, cobalt acetyl acetonate, copper acetyl acetonate, titanium acetyl acetonate, and titanium oxy acetyl acetonate. Among them, the aluminum tris(acetyl acetonate), the aluminum tris(ethyl acetoacetate), the magnesium bis(acetyl acetonate), the magnesium bis(ethyl acetoacetate), and the zirconium tetraacetyl acetonate are preferable, and in consideration of storage stability and easy availability, the aluminum tris(acetyl acetonate), the aluminum tris(ethyl acetoacetate), and aluminum bisethyl acetoacetate•monoacetyl acetonate which are the aluminum chelate complex are particularly preferable. Examples of a commercially available product include an aluminum chelate A(W), an aluminum chelate D, an aluminum chelate M (manufactured by Kawaken Fine Chemicals Co., Ltd.), and the like.

A ratio of the metal complex to the total of the alkoxy silane is preferably 20 weight % to 70 weight %, is more preferably 30 weight % to 60 weight %, and is even more preferably 40 weight % to 50 weight %.

In the embodiment of the present invention, by setting the content of the metal complex to be greater than or equal to the lower limit value described above, it is possible to set the reaction speed of the dehydration and the condensation of the silanol to be a suitable speed, and it is possible to obtain a hard coat film having a uniform film thickness and high alkali resistance.

(Inorganic Particles)

The aqueous composition of the present invention contains the inorganic particles having an average particle diameter of 60 nm to 350 nm. The inorganic particles satisfy Expression (I).

A=−0.1×B+C Expression (I):

A: Ratio (volume %) of Inorganic Particles to Total Solid Content of Aqueous Composition

B: Average Particle Diameter of Inorganic Particles (nm)

C: Coefficient, Satisfying Relationship of 50≦C≦70.

The average particle diameter B of the inorganic particles is in a range of 60 nm to 350 nm, and is preferably in a range of 65 nm to 300 nm, and is particularly preferably in a range of 70 nm to 250 nm. In a case where the average particle diameter B of the inorganic particles is less than 60 nm, it is difficult for the hard coat film to obtain sufficient antiblocking properties, and in a case where the average particle diameter B of the inorganic particles is greater than 350 nm, light is scattered in the film or on the surface of the film, and thus, a haze value increases.

Here, the average particle diameter is able to be obtained from a photograph which is obtained by observing the dispersed particles using a transmission type electron microscopy. The projection area of the particles is obtained, and a circle equivalent diameter is obtained from the obtained projection area, and thus, is set to an average particle diameter (an average primary particle diameter). Herein, the average particle diameter is able to be calculated by measuring the projection area of 300 or more particles, and by obtaining the circle equivalent diameter thereof.

The ratio A of the inorganic particles to the total solid content of the aqueous composition is 15≦A≦64. When the value of A satisfies Expression (I), the value of A increases in a case where the average particle diameter B of the inorganic particles decreases, and the value of A decreases in a case where the average particle diameter B of the inorganic particles increases. That is, when the inorganic particles are small, the inorganic particles are added at a high ratio with respect to the total solid content of the aqueous composition, and thus, a hard coat film having high antiblocking properties is able to be obtained, but in a case where the inorganic particles are added at a low ratio, a hard coat film having high antiblocking properties is not able to be obtained. In contrast, when the inorganic particles are large, the inorganic particles are added at a low ratio with respect to the total solid content of the aqueous composition, and thus, a hard coat film having a low haze value and excellent optical properties is able to be obtained, but in a case where the inorganic particles are added at a high ratio, the haze value increases, a hard coat film having excellent optical properties is not able to be obtained.

The inorganic particles are used in a portion directly under a transparent conductive film, and thus, examples of the inorganic particles include metal oxide particles having transparency and insulating properties, and the like. Particles formed of silica, alumina, zirconia, and titanium are able to be preferably used as a specific example of the metal oxide particles, and silica particles are particularly preferably used from the viewpoint of crosslinking with respect to the alkoxy silane.

Dried powder-like silica which is manufactured by combustion of silicon tetrachloride, or colloidal silica in which silicon dioxide or a hydrate thereof is dispersed in water is able to be used as the silica particles. In a case where the dried powder-like silica is used, the dried powder-like silica is dispersed in water by using an ultrasonic wave disperser or the like, and thus, the dried powder-like silica is able to be added to the aqueous composition. The silica particles are not particularly limited, and specifically, examples of the silica particles include SEAHOSTAR SERIES such as SEAHOSTAR KE-P10 (manufactured by NIPPON SHOKUBAI CO., LTD.), SNOWTEX SERIES such as SNOWTEX OZL-35 (manufactured by Nissan Chemical Industries, Ltd.), and the like.

Furthermore, it is more preferable that pH of the silica particles is adjusted to be in a range of 2 to 7 at a time point of being added to the aqueous composition. In a case where the pH is 2 to 7, the stability of the silanol which is a hydrolysate of the alkoxy silane becomes more excellent, and an increase in the viscosity of the coating liquid which occurs due to fast progress of the dehydration and condensation reaction of the silanol is able to be suppressed, compared to a case where the pH is less than 2 or greater than 7.

A ratio of the inorganic particles to the total solid content of the aqueous composition is preferably greater than or equal to 30 volume %, is more preferably greater than or equal to 35 volume %, and is more preferably greater than or equal to 40 volume %. In addition, the ratio of the inorganic particles to the total solid content of the aqueous composition is preferably less than or equal to 60 volume %, is more preferably less than or equal to 55 volume %, and is even more preferably less than or equal to 50 volume %.

Furthermore, two or more types of the inorganic particles may be used in combination, and in this case, the total amount of all types of the used inorganic particles is in the range described above. By setting the ratio of the inorganic particles to the total solid content of the aqueous composition to be in the range described above, it is possible to increase the dispersibility of the inorganic particles in the aqueous composition.

(Other Additives)

A surfactant may be added to the aqueous composition of the present invention in order to reduce friction on the surface of the coated film by improving the smoothness of the hard coat film. In addition, the hard coat film may be colored by dispersing a pigment or a dye, other fine particles, and the like. Further, an ultraviolet absorbent, an antioxidant, and the like may be added in order to improve weather resistance.

It is preferable that a pH adjusting agent is added to the aqueous composition, and thus, the pH is adjusted to be in a desired range. The pH adjusting agent is not particularly limited insofar as the pH is changed, and specifically, examples of the pH adjusting agent include a nitric acid, an oxalic acid, an acetic acid, a formic acid, a hydrochloric acid, and the like as an acid (an organic acid and an inorganic acid), and ammonia, triethyl amine, ethylene diamine, sodium hydroxide, potassium hydroxide, and the like as an alkali. The pH adjusting agent may be directly added, or may be added as a solution such as an aqueous solution. The amount of pH adjusting agent to be used is not particularly limited insofar as the pH satisfies a desired range.

In the embodiment of the present invention, it is preferable that the pH of the aqueous composition is adjusted to be 2 to 6. The nitric acid, the oxalic acid, the acetic acid, the formic acid, and the hydrochloric acid are preferable as the pH adjusting agent, and the acetic acid is particularly preferable.

(Surfactant)

Various surfactants may be added to the aqueous composition of the present invention from the viewpoint of further improving coating properties. Various surfactants such as a fluorine-based surfactant, a nonionic surfactant, a cationic surfactant, an anionic surfactant, and a silicone-based surfactant are able to be used as the surfactant.

Examples of the fluorine-based surfactant include MEGAFACE F171, MEGAFACE F172, MEGAFACE F173, MEGAFACE F176, MEGAFACE F177, MEGAFACE F141, MEGAFACE F142, MEGAFACE F143, MEGAFACE F144, MEGAFACE R30, MEGAFACE F437, MEGAFACE F475, MEGAFACE F479, MEGAFACE F482, MEGAFACE F554, MEGAFACE F780, and MEGAFACE F781 (all are manufactured by DIC Corporation), FLUORAD FC430, FLUORAD FC431, and FLUORAD FC171 (all are manufactured by Sumitomo 3M Limited), SURFLON S-382, SURFLON SC-101, SURFLON SC-103, SURFLON SC-104, SURFLON SC-105, SURFLON SC1068, SURFLON SC-381, SURFLON SC-383, SURFLON 5393, and SURFLON KH-40 (all are manufactured by ASAHI GLASS CO., LTD.), PF636, PF656, PF6320, PF6520, and PF7002 (manufactured by OMNOVA Solutions Inc.), and the like.

Specifically, examples of the nonionic surfactant include glycerol, trimethylol propane, trimethylol ethane, and ethoxylate and propoxylate thereof (for example, glycerol propoxylate, glycerin ethoxylate, and the like), polyoxy ethylene lauryl ether, polyoxy ethylene stearyl ether, polyoxy ethylene oleyl ether, polyoxy ethylene octyl phenyl ether, polyoxy ethylene nonyl phenyl ether, polyethylene glycol dilaurate, polyethylene glycol distearate, and sorbitan fatty acid ester (PLURONIC L10, PLURONIC L31, PLURONIC L61, PLURONIC L62, PLURONIC 10R5, PLURONIC 17R2, PLURONIC 25R2, TETRONIC 304, TETRONIC 701, TETRONIC 704, TETRONIC 901, TETRONIC 904, and TETRONIC 150R1 (manufactured by BASF SE), and PIONIN D-6512, PIONIN D-6414, PIONIN D-6112, PIONIN D-6115, PIONIN D-6120, PIONIN D-6131, PIONIN D-6108-W, PIONIN D-6112-W, PIONIN D-6115-W, PIONIN D-6115-X, and PIONIN D-6120-X (manufactured by TAKEMOTO OIL & FAT CO., LTD), SOLSPERSE 20000 (manufactured by The Lubrizol Corporation), NAROACTY CL-95 and NAROACTY HN-100 (manufactured by Sanyo Chemical Industries, Ltd.), and the like.

Specifically, examples of the cationic surfactant include a phthalocyanine derivative (Product Name: EFKA-745, manufactured by MORISHITA & CO., LTD.), an organosiloxane polymer KP341 (manufactured by Shin-Etsu Chemical Co., Ltd.), (meth)acrylic acid-based (co)polymers POLYFLOW No. 75, POLYFLOW No. 90, and POLYFLOW No. 95 (manufactured by kyoeisha Chemical Co., Ltd.), W001 (manufactured by Yusho Co., Ltd.), and the like.

Specifically, examples of the anionic surfactant include W004, W005, and W017 (manufactured by Yusho Co., Ltd.), SANDED BL (manufactured by Sanyo Chemical Industries, Ltd.), and the like.

Examples of the silicone-based surfactant include “TORAY SILICONE DC3PA”, “TORAY SILICONE SH7PA”, “TORAY SILICONE DC11PA”, “TORAY SILICONE SH21PA”, “TORAY SILICONE SH28PA”, “TORAY SILICONE SH29PA”, “TORAY SILICONE SH30PA”, and “TORAY SILICONE SH8400” which are manufactured by Dow Corning Toray Co., Ltd., “TSF-4440”, “TSF-4300”, “TSF-4445”, “TSF-4460”, and “TSF-4452” which are manufactured by Momentive Performance Materials Inc., “KP341”, “KF6001”, and “KF6002” which are manufactured by Shin-Etsu Chemical Co., Ltd., “BYK307”, “BYK323”, and “BYK330” which are manufactured by BYK-Chemie GmbH, and the like.

Only one type of the surfactants may be used, or two or more types thereof may be used in combination.

The added amount of the surfactant is preferably 0.001 mass % to 2.0 mass %, and is more preferably 0.005 mass % to 1.0 mass %, with respect to the total mass of the aqueous composition.

(Manufacturing Method of Aqueous Composition and Hard Coat Film)

The hard coat film of the present invention is formed by applying the aqueous composition of the present invention onto the surface of the substrate film such as a polyester film. The procedure of liquid preparation is not particularly limited, and in a method where the alkoxy silane containing an epoxy group and the alkoxy silane not containing an epoxy group are sequentially hydrolyzed, and a colloidal silica dispersion and an aluminum chelate complex are sequentially added to the hydrolysis liquid, highest solubility and highest storage stability are obtained.

It is preferable that a coating step of the aqueous composition is provided after a stretching step of the substrate film such as a polyester film. The coating of the aqueous composition is able to be performed by suitably using a known coater. Examples of the coater are able to include a spin coater, a roll coater, a bar coater, a curtain coater, and the like.

A step of drying the coating liquid is provided after the coating step. It is preferable that heating and drying are performed in the drying step. In the heating and drying, the heating is preferably performed such that the temperature of the coated film becomes higher than or equal to 160° C., is more preferably performed such that the temperature of the coated film becomes higher than or equal to 170° C., and is more preferably performed such that the temperature of the coated film becomes higher than or equal to 180° C. In addition, the temperature of the coated film is preferably lower than or equal to 220° C., and is more preferably lower than or equal to 210° C. By setting the temperature of the heating and drying to be in the range described above, it is possible to sufficiently cure the coated film, and it is possible to prevent deformation from occurring in the hard coat film. Furthermore, it is preferable that a heating time is 10 seconds to 5 minutes.

After that, the laminated film obtained after the drying step may be wound into the shape of a roll, or may be cut into the shape of a sheet.

(Hard Coat Film and Laminated Film)

As described above, the hard coat film is formed by applying the aqueous composition onto the substrate film, and by drying the aqueous composition. Herein, the hard coat film being laminated on the substrate film will be referred to as a laminated film. Furthermore, in the laminated film, in order to increase adhesive force between the hard coat film and the substrate film, an easily adhesive layer (an underlayer) may be disposed between the hard coat film and the substrate film.

The film thickness of the hard coat film is able to be controlled by adjusting the coating amount of the aqueous composition. It is preferable that the film thickness is constant in a range of 0.6 μm to 1.8 μm from the viewpoint of the hardness of the hard coat film to be obtained. In a case where the film thickness is less than 0.6 μm, sufficient hardness is rarely exhibited, and a function as the hard coat film may not be obtained, and in a case where the film thickness is greater than 1.8 μm, the internal stress of the hard coat film increases, and deformation such as curling may occur.

Centerline average surface roughness Ra on the surface of the hard coat film is able to be controlled by the particle diameter of the inorganic particles to be contained and the concentration of solid contents. It is preferable that Ra is 1.0 to 4.0 nm from the viewpoint of the antiblocking properties of the hard coat film to be obtained. In a case where Ra is less than 1.0 nm, sufficient antiblocking properties are rarely exhibited, the hard coat films are bonded to each other at the time of being superposed, and a defect may occur on the external appearance. In contrast, in a case where Ra is greater than 4.0 nm, the haze of the hard coat film increases, and visibility may deteriorate.

The centerline average surface roughness Ra on the surface of the hard coat film is able to be measured by using an atomic force microscope (AFM) or the like.

The refractive index of the hard coat film, for example, is able to be in a range of 1.44 to 1.64 at 25° C. By setting the refractive index of the hard coat film to be in the range described above, it is possible to preferably use the hard coat film in a touch panel.

A polymer compound is formed into the shape of a film by using a melting film formation method or a solution film formation method, and is able to be used as the substrate film on which the hard coat film is laminated. The polymer compound to be used in the substrate film is not particularly limited, and polyethylene terephthalate (PET), polyethylene naphthalate (PEN), polybutylene terephthalate (PBT), polybutylene naphthalate (PBN), polyarylates, polyether sulfone, polycarbonate, polyether ketone, polysulfone, polyphenylene sulfide, a polyester-based liquid crystal polymer, triacetyl cellulose, a cellulose derivative, polypropylene, polyamides, polyimide, polycycloolefins, and the like are preferable as the polymer compound. Among them, PET, PEN, the triacetyl cellulose, and the cellulose derivative are more preferable, and PET and PEN are particularly preferable.

It is preferable that such a substrate film is biaxially stretched. The biaxial stretching indicates that stretching is not monoaxially performed in each of a width direction and a longitudinal direction of the film, but is performed in both directions. In the polyester film which is biaxially stretched as described above, molecular alignment is sufficiently controlled by the biaxial stretching, and thus, extremely excellent mechanical strength is obtained. The stretching ratio is not particularly limited, and the stretching ratio with respect to one direction is preferably 1.5 time to 7 times, and is more preferably 2 times to 5 times. In particular, in the polyester film which is biaxially stretched at a stretching ratio of 2 times to 5 times around a monoaxial direction, the molecular alignment is efficiently and effectively controlled, and thus, the polyester film has extremely excellent mechanical strength, and is preferable as a polyester film.

The surface of the substrate film may be subjected to a corona treatment or a glow treatment. According to such a treatment, the surface of the substrate film is hydrophilized, and the coating properties of the aqueous composition are able to be enhanced, and thus, it is possible to further increase an adhesive force with respect to the hard coat film or an adhesive force with respect to the easily adhesive layer.

The easily adhesive layer is suitably disposed on the substrate film in order to improve the adhesiveness between the substrate film and the hard coat film and to increase the adhesive force with respect to the hard coat film. In general, the easily adhesive layer is formed by applying a coating liquid formed of a binder, a curing agent, and a surfactant onto the surface of the substrate film on which the hard coat film is disposed. Organic fine particles or inorganic fine particles may be suitably added to the easily adhesive layer. The fine particles are not particularly limited, examples of the fine particles include a metal oxide, and specifically, tin oxide, zirconium oxide, zinc oxide, titanium oxide, cerium oxide, niobium oxide, and the like are preferable, and only one type of the fine particles may be independently used, or two or more types thereof may be used in combination. Examples of a commercially available product include ET SERIES such as ET-500W, FT SERIES such as than FT-2000, SN SERIES such as SN-100P, FS SERIES such as FS-10D (manufactured by ISHIHARA SANGYO KAISHA, LTD.), and the like.

The binder used in the easily adhesive layer is not particularly limited, and at least one of polyester, polyolefin, polyurethane, an acrylic resin, or a styrene butadiene copolymer is preferable from the viewpoint of adhesiveness. In addition, it is particularly preferable that the binder has water-solubility or water-dispersibility from the viewpoint of reducing a load on the environment. Examples of a commercially available product include CARBODILITE SERIES such as CARBODILITE V-02-L2 (manufactured by Nisshinbo Holdings Inc.), TAKELAC WS SERIES such as TAKELAC WS-5100 (manufactured by Mitsui Chemicals, Inc.), and the like.

The thickness of the easily adhesive layer is able to be suitably adjusted by adjusting the coating amount thereof. It is more preferable that the thickness of the easily adhesive layer is constant in a range of 0.01 μm to 5 μm. In a case where the thickness is less than 0.01 μm, the adhesiveness becomes insufficient, and in a case where the thickness is greater than 5 μm, it is difficult to obtain adhesiveness of a homogeneous thickness, and the use amount of the solution increases or the drying time is excessively prolonged, and thus, the costs increase. A more preferred range of the thickness is 0.02 μm to 3 μm. The easily adhesive layer may be only one layer, or may be an embodiment in which a plurality of easily adhesive layers are superposed. In a case where the plurality of easily adhesive layers are superposed, the total thickness of all of the easily adhesive layers is regarded as a thickness.

(Transparent Conductive Film)

A transparent conductive film is able to be formed by further laminating a transparent conductive layer on the hard coat film. Examples of the material of the transparent conductive layer include a material to which any one of indium oxide, zinc oxide, and tin oxide, or a mixed oxide of two or more types or three or more types thereof, and other additive materials are added, and the like, and various materials are able to be used according to the purpose and the application, but the material is not particularly limited. Currently, a material which has the highest reliability and is generally used is indium tin oxide (ITO). A manufacturing method of the transparent conductive layer may be a film formation method in which the film thickness is able to be controlled, and for example, a method disclosed in JP2012-206307A is able to be used.

An electrode pattern of the transparent conductive layer is prepared by patterning an ITO conductive film. The hard coat film and the transparent conductive layer may be laminated to be in contact with each other, and an adjustment layer such as an optical adjustment layer may be laminated between the hard coat film and the transparent conductive layer. The optical adjustment layer is disposed in order to adjust a difference in refractive indices between the respective layers.

In general, an alkali solution is used at the time of laminating the transparent electrode layer on the hard coat film and patterning the transparent electrode layer. The alkali solution peels off a resist which protects the ITO conductive film. The hard coat film of the present invention has high alkali resistance, and thus, even in a case where the alkali solution is used at the time of patterning the transparent conductive layer or the like, the components for forming the hard coat film are not dissolved. Accordingly, it is possible to obtain a hard coat film having high quality and low haze, and the hard coat film is preferably used in a touch panel.

(Touch Panel)

It is preferable that the hard coat film and the transparent conductive film of the present invention are used in a touch panel, and the touch panel can be referred to the description in JP2002-48913A or the like.

The hard coat film of the present invention is able to be used in a liquid crystal display, a plasma display, an organic EL display, a CRT display, electronic paper, a touch panel, a PDP electromagnetic wave shielding film, a protective sheet for a solar cell, or a window covering film.

### EXAMPLES

Hereinafter, the characteristics of the present invention will be more specifically described with reference to examples and comparative examples. Materials, used amounts, ratios, treatment contents, treatment procedures, and the like of the following examples are able to be suitably changed insofar as the changes do not cause deviance from the gist of the present invention. Accordingly, the range of the present invention will not be restrictively interpreted by the following specific examples.

### Example 1

### Liquid Preparation of Aqueous Solution for Underlayer

The following compounds were mixed at the following formulation, and liquid preparation of an aqueous solution for an underlayer was performed.

Dispersion of Oxide Tin Fine Particles 8 parts by mass (manufactured by ISHIHARA SANGYO KAISHA, LTD., FS-10D, Concentration of Solid Contents of 20 mass %)

Polyurethane 2.8 parts by mass (manufactured by Mitsui Chemicals, Inc., TAKELAC WS-5100, Concentration of Solid Contents of 30 mass %)

Crosslinking Agent 4.2 parts by mass (manufactured by manufactured by Nisshinbo Chemical Inc., CARBODILITE V-02-L2, Diluent of 10 mass %)

Surfactant A 2.0 parts by mass (manufactured by NOF CORPORATION, RAPISOL A-90, Anionic Aqueous Solution of 1 mass %)

Surfactant B 2.0 parts by mass (manufactured by Sanyo Chemical Industries, Ltd., NAROACTY CL-95, Nonionic Diluent of 1 mass %)

Water 81 parts by mass

(Liquid Preparation of Aqueous Composition for Hard Coat Film)

Liquid preparation of an aqueous composition for a hard coat film was performed at the following formulation.

Alkoxy Silane Containing Epoxy Group 8.8 parts by mass (manufactured by Shin-Etsu Chemical Co., Ltd., KBE-403 (3-Glycidoxy Propyl Triethoxy Silane))

Alkoxy Silane Not Containing Epoxy Group 2.7 parts by mass (manufactured by Shin-Etsu Chemical Co., Ltd., KBE-04 (Tetraethoxy Silane))

Aqueous Solution of Acetic Acid 18.3 parts by mass (manufactured by Daicel Corporation., Aqueous Solution of Industrial Acetic Acid of 1 mass %)

Metal Complex 2.6 parts by mass (manufactured by Kawaken Fine Chemicals Co., Ltd., Aluminum Chelate D, Solution of Isopropyl Alcohol (IPA) of 76 mass %)

Inorganic Particles 23.4 parts by mass (manufactured by Nissan Chemical Industries, Ltd., SNOWTEX OZL-35 (Average Particle Diameter of 100 nm), Concentration of Solid Contents of 35 mass %)

Surfactant A 3.3 parts by mass (manufactured by NOF CORPORATION, RAPISOL A-90, Anionic Diluent of 1 mass %)

Surfactant B 2.3 parts by mass (manufactured by Sanyo Chemical Industries, Ltd., NAROACTY CL-95, Nonionic Diluent of 1 mass %)

Water 38.6 parts by mass

The liquid preparation was performed in the following procedures. The alkoxy silane containing an epoxy group (KBE403) was added to the aqueous solution of the acetic acid (an acetic acid of 1 mass %) and was sufficiently hydrolyzed, and then, the alkoxy silane not containing an epoxy group (KBE04) was added thereto. At this time, a ratio of KBE403 to the total amount of the added alkoxy silane (the total amount of KBE403 and KBE04) was 76.5 mass %. Next, an aluminum chelate complex was added to the mixed liquid as the metal complex in the necessary amount with respect to the alkoxy silane containing an epoxy group, and the inorganic particles (SNOWTEX: silica particles) were added thereto. Here, the surfactant A (SANDED BL) and the surfactant B (NAROACTY CL-95) were added, and water was finally added, and thus, an aqueous composition was obtained. The average particle diameter of the inorganic particles was calculated as follows. The dispersed inorganic particles were observed by a transmission type electron microscopy, and thus, a photograph was obtained. A projection area of the particles was obtained from the obtained photograph, and a circle equivalent diameter was obtained from the projection area. The circle equivalent diameters of 300 or more inorganic particles were obtained, and the average thereof was calculated as the average particle diameter (the average primary particle diameter).

Furthermore, volume % of the inorganic particles in the total solid content was 45 volume %. The volume % is calculated from a ratio of the inorganic particles to a volume which is obtained from the mass and the specific gravity of each of the components.

(Formation of Underlayer and Hard Coat Film)

A PET base (COSMOSHINE A4300 125 μm, manufactured by TOYOBO CO., LTD.) was subjected to a corona treatment, and the prepared aqueous solution for an underlayer was applied by using a wire bar of No. 4 and was dried at 150° C. for 2 minutes, and thus, an underlayer was formed. The PET base on which the underlayer was formed was subjected to a corona treatment again, and the prepared aqueous solution for a hard coat film was applied to have a film thickness as shown in the following table by using a wire bar of No. 7 and was dried at 150° C. for 2 minutes, and thus, a hard coat film was formed. Thus, a film sample of Example 1 was obtained.

The centerline average surface roughness Ra on the surface of the prepared hard coat film was measured by using an atomic force microscope (Dimension Icon, manufactured by Bruker Corporation), and thus, was 2.6 nm.

### Examples 2 to 9 and Comparative Examples 1 to 4

The liquid preparation of the aqueous solution for a hard coat film was performed by the same method as that in Example 1 except that the particle diameter and the concentration of solid contents of the inorganic particles were changed to have values shown in the following table. Then, an underlayer was formed by the same method as that in Example 1, and each prepared aqueous solution for a hard coat film was applied to have a film thickness as shown in the following table by the same method as that in Example 1, and thus, a film sample was prepared.

In Examples 2 to 9 and Comparative Examples 1 to 4, inorganic particles described below were used.

Average Particle Diameter of 10 nm: SNOWTEX O-33 (manufactured by Nissan Chemical Industries, Ltd.)

Average Particle Diameter of 80 nm: SNOWTEX OYL (manufactured by Nissan Chemical Industries, Ltd.)

Average Particle Diameter of 100 nm: Water Dispersion Body in which SEAHOSTAR KE-P10 (manufactured by NIPPON SHOKUBAI CO., LTD.) was dispersed in water by ultrasonic wave dispersion

Average Particle Diameter 200 nm: Water Dispersion Body in which SEAHOSTAR KE-P20 (manufactured by NIPPON SHOKUBAI CO., LTD.) was dispersed in water by ultrasonic wave dispersion

Average Particle Diameter 300 nm: Water Dispersion Body in which SEAHOSTAR KE-P30 (manufactured by NIPPON SHOKUBAI CO., LTD.) was dispersed in water by ultrasonic wave dispersion

In Examples 2 to 9 and Comparative Examples 1 to 4, the added amount was adjusted such that a ratio of the inorganic particles to the total solid content had a value as shown in the following table.

In addition, the average particle diameter of the inorganic particles and the centerline average surface roughness Ra of the hard coat film surface were measured by the same method as that in Example 1.

(Evaluation)

The obtained film sample was subjected to the following evaluations (1) to (4). The results are shown in the following table.

(1) Pencil Hardness

A baking treatment was performed at 150° C. for 1 hour, and the pencil hardness of the hard coat film was measured at a moving speed of 0.5 mm/second and a load of 750 g on the basis of JIS K5600-5-4 by using a both-way wear tester TRIBOGEAR (Registered Trademark) TYPE: 30S (manufactured by Shinto Scientific Co., Ltd.). The level of the pencil hardness of the hard coat film to be obtained is different according to the application, and for example, in a case where the hard coat film is used in a transparent conductive film, the pencil hardness of greater than or equal to “H” indicates that a functions as the hard coat film is satisfied.

(2) Curling Properties

A sample was prepared by cutting the film sample to have a size of width of 10 cm×length of 10 cm, and the sample was placed on a horizontal stand such that the coated surface (the inner surface of curling) is placed on the outside. The distances of four corners of the sample separated from the stand were respectively measured, and thus, the average value was calculated. The average value was determined on the basis of the following criteria. A and B are practically allowable ranges.

A: Less than 2 mm

B: Greater than or equal to 2 mm and less than 5 mm

C: Greater than or equal to 5 mm

(3) Antiblocking Properties

Two film samples were superposed such that the hard coat films were in contact with each other, and the film sample was pressed by a finger with a force of approximately 500 g/cm², and thus, antiblocking properties were determined on the basis of the following criteria by using the degree of generation of a Newton ring. A and B are practically allowable ranges.

A: No Newton ring is generated at all, and the antiblocking properties are excellent

B: A few Newton rings are generated compared to A, but are in a level which is able to be practically used

C: The Newton rings are remarkably generated

(4) Haze

A haze value was measured by using a hazemeter NDH5000 (manufactured by NIPPON DENSHOKU INDUSTRIES CO., LTD.). The haze value was measured on the basis of JIS K7136.

TABLE 1

| | Inorganic Particles | | | Hard Coat Film | | | | | |
|---|---|---|---|---|---|---|---|---|---|
| | | Average | | Centerline | | | | | |
| | Concentration | Particle | | Average | | | | | |
| | of Solid | Diameter | | Surface | Film | | | | |
| | Contents (A) | (B) | Coefficient | Roughness | Thickness | Pencil | | Antiblocking | |
| | (Volume %) | (nm) | (C) | (nm) | (μm) | Hardness | Curling | Properties | Haze (%) |
| Example 1 | 45 | 100 | 55 | 2.6 | 1 | 2H | A | A | 0.5 |
| Example 2 | 45 | 100 | 55 | 2.3 | 0.75 | H | A | A | 0.4 |
| Example 3 | 45 | 100 | 55 | 2.2 | 1.5 | 2H | A | A | 0.4 |
| Example 4 | 50 | 80 | 58 | 1.7 | 1 | 2H | A | A | 0.3 |
| Example 5 | 35 | 200 | 55 | 2.8 | 1 | 2H | A | A | 0.7 |
| Example 6 | 40 | 100 | 50 | 1.1 | 1 | 2H | A | B | 0.4 |
| Example 7 | 50 | 100 | 60 | 3.0 | 1 | 2H | A | A | 1.0 |
| Example 8 | 45 | 100 | 55 | 2.3 | 2 | 3H | B | A | 0.5 |
| Example 9 | 45 | 100 | 55 | 2.5 | 0.5 | F | A | A | 0.5 |
| Comparative | 45 | 10 | 46 | 0.4 | 1 | 2H | A | C | 0.3 |
| Example 1 | | | | | | | | | |
| Comparative | 20 | 100 | 30 | 0.7 | 1 | H | A | C | 0.3 |
| Example 2 | | | | | | | | | |
| Comparative | 45 | 300 | 75 | 4.1 | 1 | 2H | A | A | 2.0 |
| Example 3 | | | | | | | | | |
| Comparative | 65 | 100 | 75 | 3.8 | 1 | 2H | A | A | 1.7 |
| Example 4 | | | | | | | | | |

In Examples 1 to 9, it is found that the average particle diameter and the concentration of solid contents of the inorganic particles are in a desired range and satisfy Expression (I), and thus, it is possible to make the antiblocking properties and the haze value compatible, and the evaluation result of the pencil hardness and the curling is also excellent. In addition, it is found that Examples 1 to 7 in which the film thickness is in a range of 0.6 μm to 1.8 μm were more excellent than Example 8, in particular, from the viewpoint of curling properties, and are more excellent than Example 9 from the viewpoint of the pencil hardness.

In Comparative Examples 1 to 4, the particle diameter and the concentration of solid contents of the inorganic particles do not satisfy Expression (I), and thus, the antiblocking properties are not obtained, or a high haze value is obtained. Specifically, in a case where the particle diameter of the inorganic particles is small and the concentration of solid contents is low as with Comparative Example 1 and Comparative Example 2, the antiblocking properties are not able to be obtained, and in a case where the particle diameter of the inorganic particles is large and the concentration of solid contents is high as with Comparative Examples 3 and 4, the haze value increases.

### INDUSTRIAL APPLICABILITY

According to the present invention, it is possible to obtain an aqueous composition which is able to form a hard coat film having high antiblocking properties and high hardness, low haze, and suppressed curling of the film, and a hard coat film. The hard coat film of the present invention is suitable for a touch panel or the like, and has a high industrial utility value.

What is claimed is:

1. An aqueous composition, containing:
alkoxy silane containing an epoxy group;
alkoxy silane not containing an epoxy group;
inorganic particles having an average particle diameter of 60 nm to 350 nm; and
a metal complex,
wherein the inorganic particles satisfy Expression (I);
A=−0.1×B+C Expression (I):
A represents a ratio of the inorganic particles to the total solid content of the aqueous composition, B represents the average particle diameter of the inorganic particles, A is a value in terms of volume %, B is a value in terms of nm; and C represents a coefficient and satisfies a relationship of 50≦C≦70.

2. The aqueous composition according to claim 1,
wherein the inorganic particles are silica particles.

3. The aqueous composition according to claim 1,
wherein a ratio of the alkoxy silane containing an epoxy group to the total mass of the alkoxy silane containing an epoxy group and the alkoxy silane not containing an epoxy group is 20 mass % to 85 mass %.

4. The aqueous composition according to claim 1,
wherein the metal complex is an aluminum chelate.

5. The aqueous composition according to claim 2,
wherein the metal complex is an aluminum chelate.

6. The aqueous composition according to claim 1,
wherein the average particle diameter of the inorganic particles is 70 nm to 250 nm.

7. The aqueous composition according to claim 1,
wherein a ratio of the inorganic particles to the total solid content of the aqueous composition is 30 volume % to 60 volume %.

8. The aqueous composition according to claim 2,
wherein a ratio of the inorganic particles to the total solid content of the aqueous composition is 30 volume % to 60 volume %.

9. The aqueous composition according to claim 5,
wherein a ratio of the inorganic particles to the total solid content of the aqueous composition is 30 volume % to 60 volume %.

10. A hard coat film formed by curing the aqueous composition according to claim 1.

11. The hard coat film according to claim 10,
wherein centerline average surface roughness Ra is 1.0 nm to 4.0 nm.

12. The hard coat film according to claim 10,
wherein a film thickness is 0.6 μm to 1.8 μm.

13. The hard coat film according to claim 11,
wherein a film thickness is 0.6 μm to 1.8 μm.

14. A laminated film, comprising:
a substrate film; and
the hard coat film according to claim 10 which is formed on at least one surface of the substrate film.

15. A laminated film, sequentially comprising:
a substrate film;
an easily adhesive layer;
the hard coat film according to claim 10; and
an optical adjustment layer.

16. A transparent conductive film, comprising:
the hard coat film according to claim 10; and
a transparent conductive layer formed on the hard coat film.

17. A touch panel, comprising:
the laminated film according to claim 14.

18. A touch panel, comprising:
the transparent conductive film according to claim 16.
